(19) United States
(12) Patent Application Publication
(10) Pub. No.: US 2018/0119392 A1
(43) Pub. Date: May 3, 2018

(54) SOLAR STILL PYRAMID

(71) Applicant: Abraham Kohl, Leeton, MO (US)

(72) Inventor: Abraham Kohl, Leeton, MO (US)

(21) Appl. No.: 15/798,121

(22) Filed: Oct. 30, 2017

Related U.S. Application Data
(60) Provisional application No. 62/416,834, filed on Nov. 3, 2016.

(51) Int. Cl. E03B 3/02; C02F 1/14

(52) U.S. Cl. CPC E03B 3/02; C02F 1/14

(57) ABSTRACT

Disclosed herein is a pyramidal structure for distilling water and for collecting rainwater. The structure has five or less faces, including the base, and has a means for centralizing condensate.

### CROSS REFERENCE TO RELATED APPLICATION

This application claims priority to U.S. Provisional Application No. 62/416,834 filed on Nov. 3, 2016 and titled “Solar Still Pyramid.”

### FIELD

This document relates to a device and method for purifying water.

### BACKGROUND

As the world population rises, access to potable water becomes more and more important. A need exists for purifying water from the environment without ongoing energy costs. A needs exists for creating such a solution that can be deployed quickly, as well as that which can be expanded quickly.

The need for rapid deployment has application in outdoor activities, military activities, and if the need can be met at minimal cost, the need for rapid deployment of a water purification system can be applied to any region of the world in which there is no consistent access to potable water.

Similarly, the need to expand and disassemble for transport has application in many military activities.

Typical zero-emission water purifiers evaporate water to purify, and then collect water at the edges. Such water purifiers are not adaptable, particularly in that they cannot be transported and quickly deployed over non-potable water.

### SUMMARY

Disclosed herein is a pyramidal structure with an upward facing apex that contains a downward facing vertex that directs a substantial amount of condensation into a desired location. With the downward facing vertex, a water purifier or still may be easily transportable, easily modularized, and easily adaptable. The downward facing vertex is essentially an inversion of the upward facing apex at the top of the pyramidal structure.

The water purification systems disclosed herein leverages the downward facing vertex to direct water in a central reservoir. Surrounding the central reservoir can be damp soil, or unpurified water. The unpurified water is water that has not been distilled or has not become condensate. By placing the downward facing vertex directly above the reservoir, condensation that collects on the water purification system will drip down to the inverted tip and then drip into the central reservoir. Thus, the invention may be quickly put on the top of swampy water or brackish water or salt water and the inversion will direct water to the central reservoir. The central reservoir is more appealing than collecting the water at the periphery, because when the water is collected along the periphery, the collection must run the entire perimeter of the footprint of the pyramid water purification system and therefore it will be long and shallow. The central reservoir allows for simple, concentrated collection of purified water-collection at the bottom sides requires a long trough for collection.

The water purification system disclosed herein takes advantage of pyramidal shapes and, in one embodiment, comprise a single apex with a single downward facing vertex below the apex and inside the pyramid. In another embodiment, the pyramid is extended to embody a wedge shape with an inverted wedge trough inside the wedge shape. The wedge shape is a polyhedron comprised of two triangles and three trapezoid faces. The wedge shape has an upper ridge that is above the base, but which runs in a plane parallel to the base. The wedge shape is essentially an extended pyramid, or stretched out pyramid, having an upper ridge and an inverted wedge trough below the upper ridge.

The pyramid and the extended pyramid shape has distinct advantage. The pyramid shape creates volume while minimizing the number of flat faces and without using curvature such as with a sphere. Volume is necessary for creating an enclosed still, but it is desirable to minimize the number of flat faces for simple deployment and simple scaling. It is also desirable to avoid curved surfaces, which tend to be expensive or difficult to fabricate. A triangular pyramid, or tetrahedron, has the minimum number of flat faces, four faces, on a three dimensional shape. A square pyramid, or pyramid with any quadrilateral base, has the second most, with five faces. The square pyramid, however, can be extended into a wedge, which makes the square pyramid versatile, in that it can be extended infinitely, without adding any additional faces.

Additionally, a pyramidal structure supports itself well. Unlike with a box, wherein substantial force is directed on the flat roof, the faces of the pyramid or the edges of the pyramid lean up against each other, and thereby support each other.

The faces of the pyramid are transparent or translucent, so that when the water purification system is placed under the sun, the volume under the faces that covers the pyramid heats up, causing evaporation. The gaseous water then condenses on the inside of the faces. The water that condenses on the downward facing vertex will drip into the central reservoir. The remaining water will fall to the sides.

In the preferred embodiment of the invention, the water that falls to the sides can be collected with a base, or, for if more rapid deployment is desired, the base need not be included, so that the condensing water will just flow back to the non-potable section before eventually circulating into the central reservoir. The preferred embodiment of the invention also allows customization, so that utility reservoirs can be added to collect water at the sides. The utility reservoirs, however, are detachable from the water purification system, and also double as rain water catchers when the utility reservoirs are placed outside the pyramidal structure. Flaps at the bottom of the purifier can be used to direct water into the utility reservoirs. In the preferred embodiment, there will be a plurality of utility reservoirs available, preferably, one for each side. The utility reservoirs can be attached to the pyramidal structure with methods known in the art, such as snap buttons.

The pyramidal water purification system is portable and is comprised of a series of frames. The frames can all be interconnected, and in a preferred embodiment, are inflatable. An impermeable webbing can connect the inflatable frame supports. The impermeable webbing is similar to the impermeable webbing commonly found as the non-inflatable portions of inflatable pool toys as well as other webbing methods known in the art. Collapsible rods are also adequate for the frame, but less preferred.

In the preferred embodiment, the pyramidal water purification system floats, so that it can be placed on a large body of water. In this embodiment, only having the central reservoir is sufficient. The central reservoir will also float and the position of the central reservoir will be maintained so that it remains below the inversion. In the preferred embodiment, the buoyancy in water comes from the tubing in the edges. The tubing may be inflatable.

Another application of the downward facing vertex is an inverted wedge that runs along the extended pyramidal structure that is modular (e.g. can be scaled) and can be extended or decreased to adapt to changing purified water needs. The inverted wedge runs the distance of the extended pyramid that can be extended a considerable distance (hundreds of yards). Using a plurality of identical panels, the extended pyramid can be customized to the desired length just by adding more panels that are connected with connector pieces. In this way, the purification system is a modularized structure that can quickly be adapted to changing needs or changing conditions that impact the amount of water that will evaporate and condense. The panels can be squares or triangles, and will fit together like bricks with the connector pieces instead of mortar connecting the bricks.

In another embodiment, the extended pyramid is portable and inflatable. The base is inflatable and made to float on a pool or on a pond or any other body of water. The portable extended pyramid has inflatable supports and an impermeable and transparent webbing connects the inflatable supports, the transparent webbing being the faces of the pyramid. The base for the portable extended pyramid has outer rainwater reservoirs for collecting rainwater and condensate reservoirs, as well as a central reservoir for collecting purified condensate water. In the preferred embodiment, the base has holes that connect the rainwater reservoirs and condensate reservoirs. In another embodiment, the lower pyramid base supports have holes that may connect the rainwater with the condensate water. In the second embodiment, the lower pyramid base sits on a low point. Similarly, tubing connects the central reservoir to the condensate reservoirs.

### BRIEF DESCRIPTION OF DRAWINGS

FIG. 1A shows the portable pyramid purification system having a four-sided base.

FIG. 1B shows the portable pyramid purification system having a three-sided base.

FIG. 1C. shows the portable pyramid purification system with the faces and flaps.

FIG. 2A shows the modularized pyramid still with panels.

FIG. 2B shows the modularized pyramid extended with additional panels.

FIG. 2C shows the inverted wedge used to direct condensate.

FIG. 2E shows the connectors.

FIG. 2F shows a particular block used in the base.

FIG. 2H shows a particular block used in the base.

FIG. 2G shows a particular block used in the base.

FIG. 2I shows a partial view of the base.

FIG. 2D shows the critical components of the extended pyramid still, including the base, the connector pieces and the inverted wedge trough, and the rectangular panels that make up the inverted wedge trough and faces.

FIG. 3A shows the portable extended pyramid.

FIG. 3B shows the base for the portable extended pyramid.

### DETAILED DESCRIPTION OF DRAWINGS

The following detailed description of the invention references the accompanying drawings that illustrate specific embodiments in which the invention can be practiced. The embodiments are intended to describe aspects of the invention in sufficient detail to enable those skilled in the art to practice the invention. Other embodiments can be utilized and changes can be made without departing from the scope of the current invention. The following detailed description is, therefore, not to be taken in a limiting sense. The scope of the current invention is defined only by the claims, along with the full scope of equivalents to which such claims are entitled.

In this description, references to “one embodiment”, “an embodiment”, or “embodiments” mean that the feature or features being referred to are included in at least one embodiment of the technology. Separate references to “one embodiment”, “an embodiment”, or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments, but is not necessarily included. Thus, the current technology can include a variety of combinations and/or integrations of the embodiments described herein.

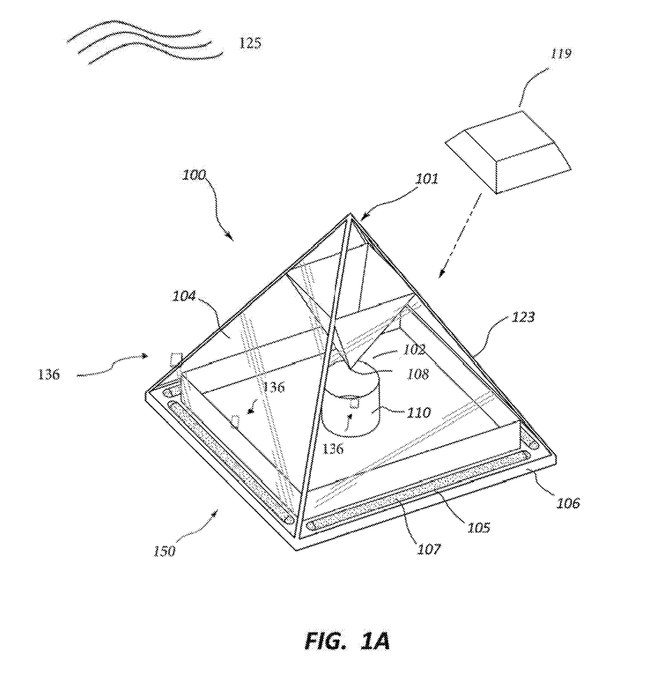

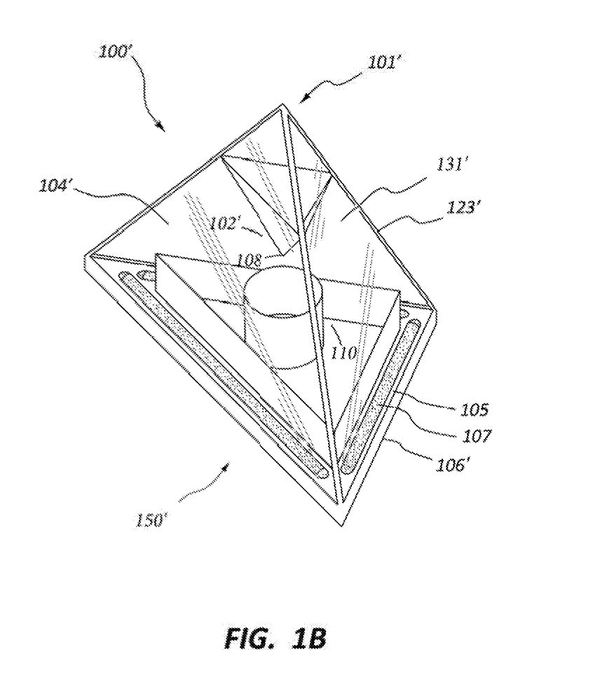

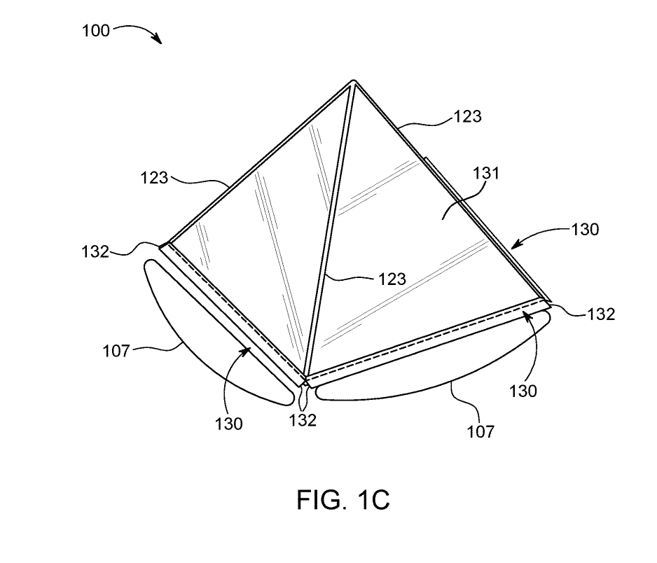

Disclosed herein is a pyramidal water system for obtaining drinking water or purified water by distilling water and by collecting rain water. The invention produces distilled water or condensate that can be used as drinking water. As seen in FIGS. 1A, and 1C, the pyramid water system 100 consists of square pyramid, or pyramid having four faces 131 plus the base 150, an upward facing apex 101 that contains a downward facing vertex 102 that directs a substantial amount of condensation into a specific, centralized location. The base 150 is the area at the bottom of the pyramid but does not need to be a covered base, and in the preferred embodiment, the pyramid does not have a material that covers the bottom, but does have base edges 106 holding the other edges 123 together. The four faces 131 and the four edges 123 create an enclosure configured for creating condensation on the inside of the device 100. The downward facing vertex 102 minimizes the size needed for a purified water container by focusing much of the condensate into the central reservoir 110. The central reservoir 110 is configured so that it can be used as a drinking cup, and in the preferred embodiment, is a cylinder having a circular perimeter. In the preferred embodiment, the downward facing vertex 102 has a tip 108 that directs condensate into the central reservoir 110. The downward facing vertex 102 makes the pyramidal structure easily transportable, easily modularized, and easily adaptable because a large or elongated collection device is not necessary, making the water purifier simple. The diamond shaped space above the downward facing vertex 102 and below the upward facing apex 101 is enclosed and observations have shown that it accelerates the distillation process. The enclosed space adds surface area for condensate or rainwater to collect on the outside of the device 100 and increases the number of reflective surfaces (increasing heat). Additionally, the pyramidal structured purifier 100 has additional features, such as the utility reservoirs 107 which can be configured to catch water near the perimeter of the purifier in instances where there is insufficient moisture to produce condensate in the central reservoir 110. The downward facing vertex 102 is essentially an inversion of the upward facing apex 101 at the top of the pyramid water system 100.

The water purification system disclosed herein leverages the downward facing vertex 102 to direct water in a central reservoir 110. Surrounding the central reservoir 110 can be unpurified water or even just damp soil. By placing the downward facing vertex 102 directly above the reservoir, condensation collecting on the water purification system will drip down to the inverted tip and then drip into the central reservoir 110. Water will collect on the outside of the downward facing vertex 102 and that water will also drip into the central reservoir 110 because the tip 108 is located directly above the central reservoir 110. Thus, the invention may be quickly put on the top of swampy water or brackish water or salt water and the inversion will direct water to the central reservoir. As will be described in more detail later, the device 100 can be quickly inflated and used to create safe drinking water. The central reservoir 110 is more appealing than collecting the water at the sides, because when the water is collected at the bottom sides, the collection must run the entire perimeter of the footprint of the pyramid water purification system. The central reservoir allows for simple, concentrated collection of purified water-collection at the bottom sides requires a long trough for collection.

The pyramid water system 100 has edges 123 that make up the frame of the pyramid, with base edges 106 making up the frame of the base 150. In FIG. 1A, there are four base edges 106 each connecting two of the four edges 123. In the preferred embodiment, the edges 123 of the pyramidal structure are about one inch diameter tubing that provides structure. This tubing can be inflatable tubing or pipe. Likewise, the utility reservoirs 107 also have frames 105, and in the preferred embodiment, the frame 105 is comprised of one and one half inch tubing with a plastic sheeting, wherein the plastic sheeting is loose so that the sheeting can hold water. The pyramid water system 100 also has a trough 104 that can be used to hold the non-potable water that may consist of wastewater, brackish water or any other type of water not ready for human consumption. The trough 104 can be detached from the pyramidal structure, and such customization may be applied to activities such as backpacking, where the minimal payload is desired. In the preferred embodiment, the trough 104 is comprised of a frame made from half inch tubing, with plastic outlining the bottom and sides. This tubing can be inflatable tubing or pipe. The central reservoir 110 is made up of half inch tubing frame, also with plastic making is substantially a cylinder without a top. In the preferred embodiment, the tubing is similar to the inflatable sections of an inflatable pool toy. In this preferred embodiment, the edges are all interconnected and can be inflated at once. Additionally, detachable tubing 125 can be added to interconnect the trough 104 and central reservoir to the edges so that the entire device can be inflated at once.

A splash guard 119 can be added on top of the trough 104 to prevent water from the trough 104 from splashing into the utility reservoirs or splashing on the inside of the faces of the pyramid. The splash guard 119 has sides, but it does not have a top or bottom. The sides of the splash guard 119 are angled to follow just beneath or away from the inside of the faces of the pyramid. The splash guard 119 is particularly useful when the water purifier is used over turbulent water. The splash guard 119 has a frame that, in the preferred embodiment, is made from one half inch tubing with plastic on the sides. The splash guard 119 may be integral to the trough 104.

The pyramid water system 100′ shown in FIG. 1B has a triangular base 150′ making this three dimensional structure a triangular pyramid or tetrahedron, having three faces 131′ plus the base 150′. The pyramid water system 100 shown in FIG. 1A has a square or rectangular base. The pyramid water system 100′ is comprised of edges 123′ and a trough 104′ with a triangular base and an apex 101′ comprising the top confluence of three edges 123. The downward facing vertex 102′ has a tip 108 that directs condensate into the central reservoir 110. The pyramid water system 100′ contains utility reservoirs 107, and may eight utility reservoirs when operated as a still and as a rain collection device.

FIG. 1C shows the pyramid water system 100 with faces 131 between the edges 123 (the inverted edge, and other aspects are not shown for simplicity) and the base edges 106, and the edges 123 are made of tubing in the preferred embodiment. The four faces 131 enclose the sides of the pyramid water system 100, so that there is no cover or material on the bottom of the pyramid. In the preferred embodiment, the faces 131 are transparent and are integrated with the edges 123, the faces 131 comprising a single layer of transparent material such as plastic and the edges 123 comprising the same plastic, but with two layers so that the edges 123 can hold air and inflate to provide structure for the pyramid water system 100. The faces 131 are made from a material or materials that block only a minimal amount of UV energy. Turning to FIG. 1B, faces 131′ will enclose pyramid water system 100′ by connecting edges 123′ with each other and with base edges 106′.

In the preferred embodiment, the pyramid water system 100 has two flaps, outside flaps 130 and inside flaps 132, at the ends at the bottom of the pyramid. The pyramid water system 100 will have eight total flaps, two at each side of the base 130 and 132, and the pyramid water system 100′ will have six flaps, two at each side of the base 130 and 132. The flaps are substantially identical except for that one flap is on the outside and one flap is on the inside and both connect to the pyramid at substantially the same point, at the bottom of the faces 131. The flaps 130 and 132 support water flowing into the utility reservoirs 107. When used as a rain collection device, the outside flaps 130 are positioned to direct water into the utility reservoirs 107, which can be moved to the outside of the purifier since they are capable of being detached. When used as a portable still, the inside flaps 132 are positioned above the utility reservoirs 107 that are inside of the pyramid to direct condensate into the utility reservoirs. The pyramid water system 100 can be used with multiple utility reservoirs, and the pyramid water system 100 is capable of operating as a rain collection device and as a still at the same time.

Another central aspect of the pyramid distillation invention is an extended pyramidal or wedge shaped structure. The faces over the pyramid are transparent or at least translucent, so that when the water purification system is placed under the sun, the volume under the faces that cover the pyramid heats up, causing evaporation. The gaseous water then condenses on the inside of the purifier. The water that condenses on the downward facing vertex will drip into the central reservoir. The remaining water will fall to the sides. The material may be a polymer or plastic such as polyvinyl chloride (PVC), rubber, latex, or polychloroprene. In the preferred embodiment, the faces are integral to the frame, however, the invention is intended to also encompass the faces as being a separate cover that is placed over the edges 123 making up the pyramidal frame.

In the preferred embodiment of the invention, the water that falls to the sides can be collected with utility reservoirs 107, or, for if more rapid deployment is desired if carrying a lighter payload is desired, such as for backpackers, the base need not be included. When the invention is customized without the attachable utility troughs 107, the condensing water will just flow back to the non-potable section. The preferred embodiment of the invention also allows customization, so that utility reservoirs 107 can be added to collect water at the sides. The utility reservoirs 107, however, are detachable from the water purification system, and also double as rain water catchers when the utility reservoirs 107 are placed outside the pyramidal structure. Flaps 130 at the bottom of the purifier can be used to direct water into the utility reservoirs. In the preferred embodiment, there will be a plurality of utility reservoirs 107 available, preferably, one for each side. The utility reservoirs 107 can be attached to the pyramidal structure with methods known in the art, such as snap buttons.

The pyramidal water purification system is portable and is comprised of a series of frames. The frames can all be interconnected with detachable tubing 125 that connects to ports 136 on all supports, and in a preferred embodiment, are inflatable. The tubing can be connected the ports 136 so that the entire system can be inflated at once, and the tubing 125 can be removed and the port 136 can be closed to hold air. Collapsible rods or piping are also adequate for the frame.

In the preferred embodiment, the pyramidal water purification system floats, so that it can be placed on a large body of water. In the preferred embodiment, the hollow tubing and thin faces provide buoyancy. Floatation can be achieved by other methods known in the art. In this embodiment, only having the central reservoir is sufficient, as the trough need not be used to hold dirty or otherwise undrinkable water. The central reservoir will also float and the position of the central reservoir will be maintained so that it remains below the inversion. In this embodiment, the central reservoir 110 may hang from the downward facing vertex 102. However, the utility reservoirs may be applied to collect additional purified water.

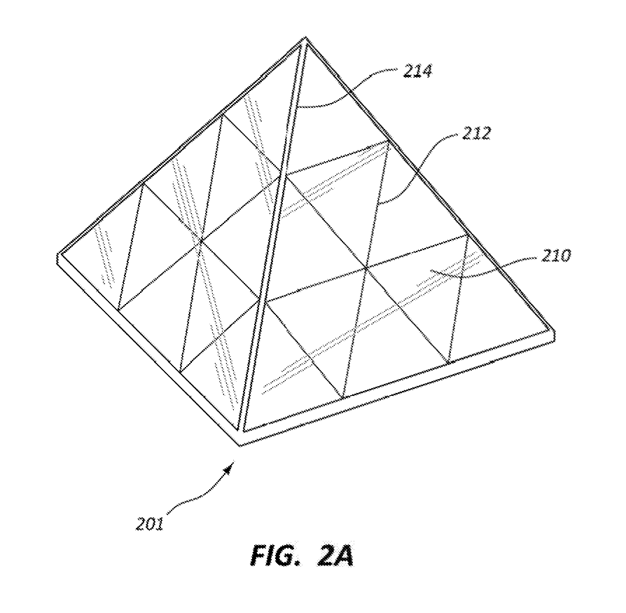

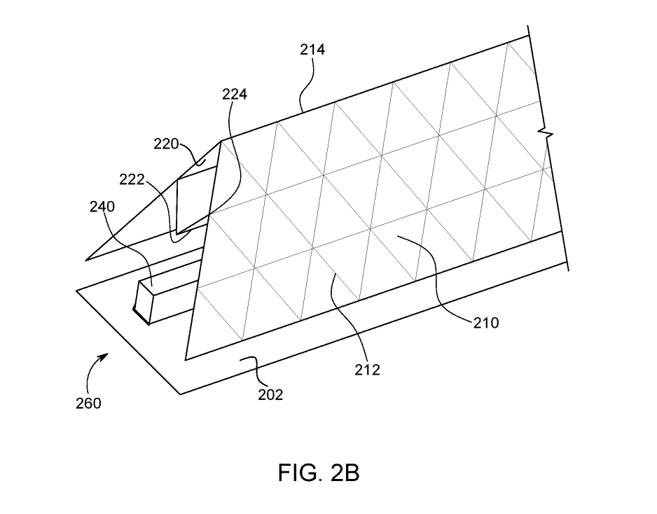

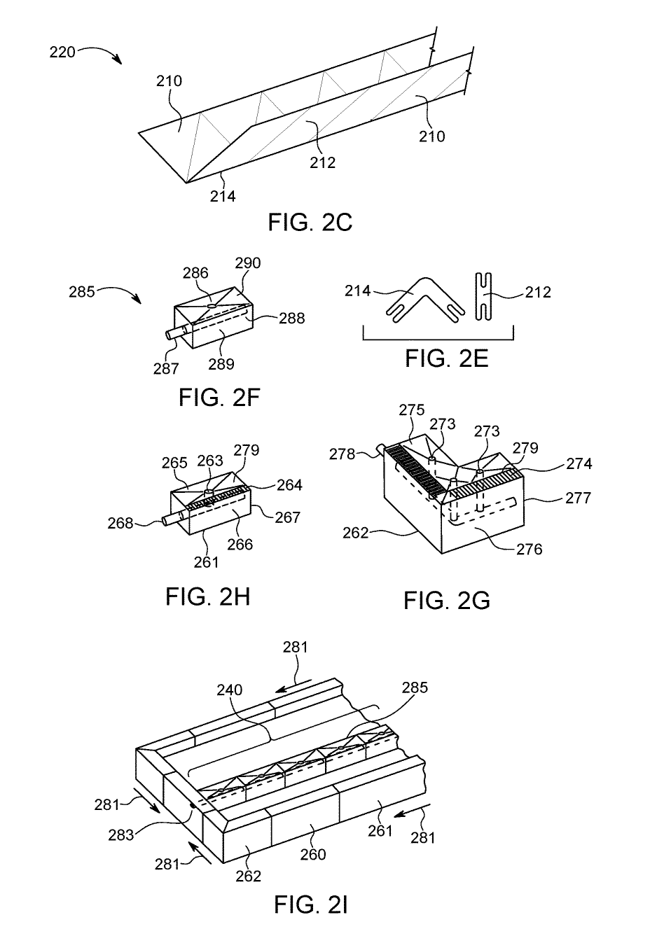

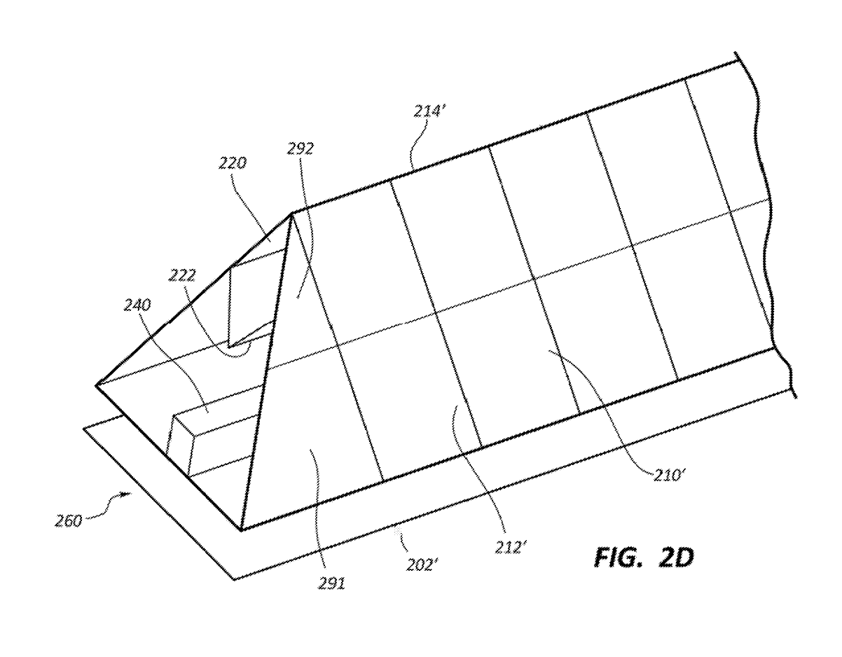

Another embodiment of the pyramid distillation invention is a larger scale, and scalable version of the pyramid purification system and is shown in FIG. 2A. The scalable purification system 201 is comprised of a series of interconnected panels 210 connected by middle connectors 212 and edge connectors 214, shown in more detail on FIG. 2C. This version of the invention can be used industrially or for multiple homes. The scalable purification system is generally translucent or transparent. The preferred embodiment of the scalable purification system 201 is a pyramid having five faces including the base. Since the scalable purification system 201 is comprised of interconnected panels 210, the system can be scaled, or extended by adding more interconnected panels 210 coupled to one another by additional middle connectors 212 and edge connectors 214 as the scaled purification system 202 shows in FIG. 2B. In the scaled purification system 202, additional panels are added to extend the face so that the scaled purification system 202 is a wedge shape, which still has five faces including the base. On the scaled purification system 202 shown in FIG. 2B, one face is removed to expose the condensation component, which is comprised of an inverted wedge 220 with a condensate ridge 222 that directs condensate to the extended central reservoir 240. The inverted wedge 220 extends from a track 224 that is on a line that is approximately two thirds of the way up each extend face. The scaled purification system 202 sits on a base 260. The base 260 does not necessarily include a flooring. In the preferred embodiment, the base 260 is comprised of a wall having a rectangular footprint with a collection component or central reservoir 240 running down the middle. The wall is comprised of extender blocks and corner blocks. In the preferred embodiment, the base is comprised of recycled black plastic.

The interconnected panels 210 are preferably triangles, but the invention contemplates other embodiments, such as panels that are rectangles, as the panels 210′ are in FIG. 2D. These panels 210′ are connected by different middle connectors 212′ and different edge connectors 214′ to mate up against each other at right angles as opposed to sixty degree angles as with 212 and 214. The rectangular panels 210′ comprise nearly the entire face of the scaled purification system 202′, however, special end pieces 292 and 291 are needed at the ends of the wedge shape. The interconnected panels 210 and 210′ are both useful in making the system adaptable to various water applications.

The connectors (middle connectors 212 and 212′ and edge connectors 214 and 214′) achieve an interlocking function by attached or separate tongue and groove fitting, as demonstrated by the detail on FIG. 2C-2. The pronged fittings shown on 212, 212′, 214, and 214′ fit over an interconnected panel 210 or 210′.

The base for the scalable and scaled purification system 201 and 202 is shown in FIGS. 2C-3, 2C-4, 2C-5, and 2C-6. The base for the scalable purification system 201 shown in FIG. 2B can be scaled to become a rectangle and can be expanded as needed by adding extender blocks 261. The base 260 is comprised of blocks which are further comprised of corner blocks 262, extender blocks 261, and central blocks 285. The blocks fit together with male and female piping connections, which serve to connect the blocks as well as to flow distilled water to a central point. Referring to the detail in FIG. 2C-5, the corner blocks 262 are right angles and go at each corner of the base 260. These blocks 262 have grating 274 at the outer edge for collecting rainwater which can then be distilled and collected in the central reservoir after evaporating and then condensing on the inside of the panels. The blocks 262 and 261 are generally hollow so that the water falling through the grating falls into the base. The hollow configuration allows for the piping to be maintained easily. The blocks 262 also have slopes 275 directed towards low points 273 for collecting condensate. Between the sloped surface 275 and the grating 274 is a line 279 where the scaled or scalable purification system will sit. The corner blocks also have a piping system 276 with a male fitting 278 and a female fitting 277 for connecting to additional blocks. The low points 273 flow into the piping system 276 that runs through the blocks that are on the outside of the base 260. The base 260 shall be sloped 281 so that the water flows into the central reservoir 240 at a central tee 283 from the piping system 276 outside of the base 260.

The extender blocks 261 are similar to the corner blocks but are not right angles. Additional extender blocks 261 can be added infinitely to extend the purification system. The extender blocks 261 have a piping system 266 that connects to the piping system 276 of the corner blocks 262 or other extender blocks using the male fitting 268 or 278 corresponding to another female fitting 267 or 277 so that piping system 266 runs with piping system 276. Referring to the detail in FIG. 2C-4, the extender blocks 261 also have a sloped surface 265 sloping towards a low point 263 which then flows to the piping system 266. The overall piping system 266 and 276 are interconnected and run along the outside of the base 260. The extender block 261 also has a grating 264 for collecting rainwater. The rainwater falling through the grating 264 will flow directly down to the bottom of the block along the bottom into the base 260 where it is retained by the wall created by the extender blocks 261 and corner blocks 262 and under the wedge shaped structure 202. The rain water will there be distilled before becoming condensate and flowing into the central reservoir 240. In between the grating 264 and the sloped surface 265 is a line 279 where the scaled or scalable purification system will sit.

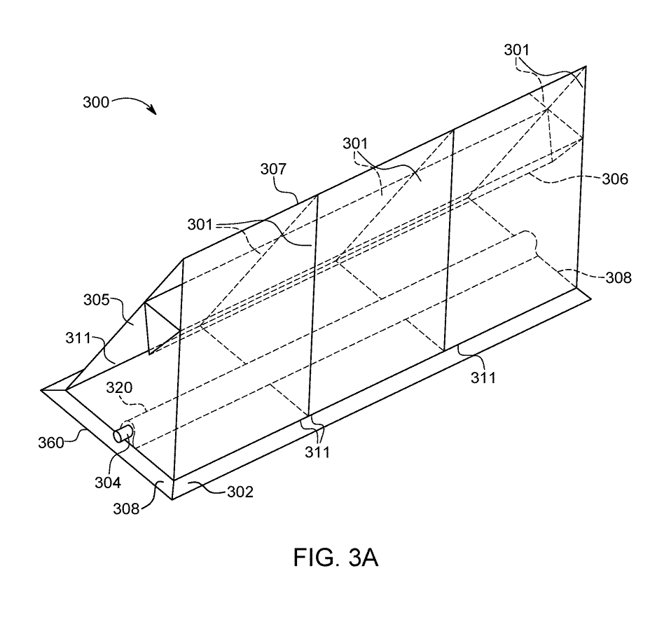

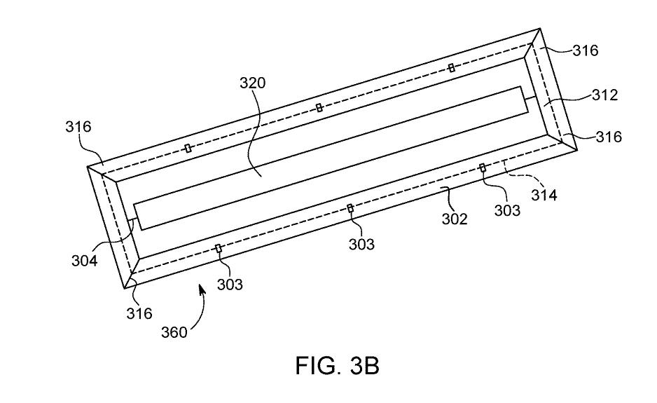

The central blocks 285, shown in detail in FIG. 2C-3 are similar to the other types of blocks but they will not collect rainwater, so there is no grating. The central blocks have a sloped surface 290 with a low point 286. The low point 286 is connected to a piping system 289 that has a male fitting 287 and a female fitting 288.

FIG. 2C-1 shows a detail of the inverted wedge 220 comprised of triangular interconnected panels 210. The inverted wedge 220 is further comprised of edge connectors 214 and middle connectors 212 for an elegant, consistent design that can be easily scaled.

FIG. 2C-6 shows a detail of the base with the central reservoir and the retaining walls created by blocks 261 and 262 and the central condensate line is supported with central blocks 285. The base condensate line in the base is sloped 281 so that water will flow to a central location. FIG. 2C-6 shows the slopes moving all to the same point 283, but the point can be in areas other than what is shown in FIG. 2C-6.

In another embodiment of the invention, the five faced pyramidal structure is extended to create an inflatable purification system 300 comprising a wedge shaped structure with an inverted wedge trough 305 as shown in FIG. 3A. The purification system 300 is supported by supports 301, with the supports 301 at the ends connected at the bottom with a bottom connection 308. The supports 301 are further connected to one another with additional bottom connections 311. In the preferred embodiment, these supports 301 and connections 308 and 311 are inflatable.

The purification system has a high edge 307 and a condensate ridge 306 for dripping condensate into the central reservoir 320. Referring to FIG. 3A and 3B, the bottom connections 308 on the water purification system sit on a base 360, and more specifically, on a footprint 314 on the base 360. The footprint 314 is generally a rectangle having parallel sides. Outside the footprint 314 but on the base 360 is a rainwater reservoir 302. Inside the footprint but on the base 360 is a condensate reservoir 312. In the preferred embodiment, the condensate reservoir 312 and the rainwater reservoir 302 are segmented into four separate compartments by separators 316 at the corners. The separators 316 are created by any means in the art known to make a high point.

The rainwater reservoir 302 and the condensate reservoir 312 may be connected through tubing 303 that connect the two. Further, the condensate reservoir 312 can be connected to the central reservoir 320 through tubing 303 and connection 304.

I claim

1. A pyramid water distillation device comprising,
an upward facing apex comprising edges and faces, the faces having an inside and an outside, the edges and faces configured to create an enclosure, the upward facing apex configured to enclose
a downward facing vertex configured for directing condensate to a central reservoir and
a trough having containment walls,
the trough containing the central reservoir
the central reservoir located near the center of the trough and
located directly beneath the downward facing vertex:

2. The pyramid water distillation device of claim 1, further comprising a plurality of utility reservoirs configured for collecting water that drips from the inside or the outside of the faces of the upward facing apex.

3. The pyramid water distillation device of claim 2, wherein the faces of the upward facing apex have flaps at the bottom of the faces configured for directing water into the utility reservoirs.

4. The pyramid water distillation device of claim 1, further comprising a splash guard configured to prevent splashing.

5. The pyramid water distillation device of claim 1, wherein the downward facing vertex is directly below the upward facing vertex.

6. The pyramid water distillation device of claim 1, wherein the trough and the central reservoir are detachable and can be removed.

7. The pyramid water distillation device of claim 1, wherein the edges are comprised of collapsible rods.

8. The pyramid water distillation device of claim 1, wherein the faces of the upward facing apex are generally translucent.

9. The p pyramid water distillation device of claim 1, wherein the faces of the upward facing apex are generally transparent.

10. The pyramid water distillation device of claim 1, wherein the central reservoir is configured as a drinking cup.

11. The pyramid water distillation device of claim 1, wherein the pyramid water distillation device is configured to float.

12. The pyramid water distillation device of claim 1, wherein the edges are inflatable.

13. The pyramid water distillation device of claim 1, wherein the edges, the trough, the downward facing matrix are all inflatable and are interconnected via ports and detachable tubing.

14. A modularized structure comprising
a plurality of panels coupled together with connector pieces configured as a first wedge
a condensation component comprising panels and connector pieces, the condensation component coupled to the inside of the first wedge, the
condensation component configured to direct condensate to a central location
a base having a retaining wall and a condensate water channel, the retaining wall further comprising a plurality of blocks and corners configured for isolating condensate from unpurified water.

15. The modularized structure of claim 14, wherein the blocks and corners are coupled together with male and female tubing configured to collect condensate.

16. The modularized structure of claim 14, wherein the blocks and the corners are generally hollow.

17. The modularized structure of clam 14, wherein the base is comprised of recycled black plastic.

18. A modular structure comprising
a base having walls and containing a central reservoir and
an outer wedge having a horizontal top edge,
the outer wedge containing an inverted wedge having a horizontal low edge and
wherein both the outer wedge and the inverted wedge are comprised of a plurality of panels.

19. The plurality of modular structures of claim 18, wherein the central reservoir is beneath the horizontal low edge.

20. The plurality of modular structures of claim 18, wherein the walls are comprised of corner blocks and extender blocks.
